(19) United States
(12) Patent Application Publication
(10) Pub. No.: US 2005/0127032 A1
(43) Pub. Date: Jun. 16, 2005

(54) Master for concavo-convex pattern transfer and method for manufacturing stamp for manufacturing information recording medium

(75) Inventors: Katsuyuki Nakada, Tokyo (JP); Kazuhiro Hattori, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/991,779

(22) Filed: Nov. 19, 2004

(30) Foreign Application Priority Data
Nov. 28, 2003 (JP) 2003-400562

(51) Int. Cl. B44C 1/22

(52) U.S. Cl. 216/41

(57) ABSTRACT

A method for manufacturing a master for concavo-convex pattern transfer, which enables highly accurate manufacture of a master carrying a concavo-convex pattern including a convex portion at a large aspect ratio, and a method for manufacturing a stamp using the master are provided. A mask layer is formed in a predetermined pattern on an object to be etched having a higher rigidity than that of a resist material. The object to be etched is then etched so as to form a concavo-convex pattern on the surface thereof to obtain a master for concavo-convex pattern transfer. A material having a lower etching rate than that of the resist material and that of the object to be etched is used as a material of the mask layer.

### BACKGROUND OF THE INVENTION

1. Field of the Invention

The present invention relates to a master used for transferring a concavo-convex pattern in the field of manufacture of information recording media and to a method for manufacturing a stamp.

2. Description of the Related Art

Some information recording media include a recording layer or the like formed in a concavo-convex pattern. In order to form the concavo-convex pattern, a stamp is conventionally used.

For example, a concavo-convex pattern such as a pit or a groove for information transfer is formed on a substrate of an optical recording medium such as a CD (Compact Disc) or a DVD (Digital Versatile Disc). An example of a method for manufacturing a substrate of an optical recording medium is given as follows. First, a resist material is applied onto a glass substrate. The resist material is exposed to light and developed by a lithography technique so as to be partially removed. As a result, a glass master having a concavo-convex pattern formed thereon (master for concavo-convex pattern transfer) is obtained. After a conductive film is formed on the glass master by electroless plating, a thin film made of Ni or the like is formed there on by electrolytic plating. By stripping the thin film and conductive film off from the glass master, a stamp is obtained. The stamp is placed in a mold and then a resin material such as polycarbonate is injected into the mold cavity for injection molding. As a result, a substrate carrying a concavo-convex pattern such as a pit or a groove for information transfer is obtained. In some cases, in order to improve productivity or the like, a metal master is first manufactured by electroless plating and electrolytic plating from the glass master. After a thin film formed on the metal master by electrolytic plating, the thin film is stripped off from the metal master to form a stamp. In some other cases, a stamp is manufactured by repeating the electrolytic plating.

In addition to the optical recording media, the use of a technique of transferring a concavo-convex pattern using a stamp as described above is also expected in a manufacture process of a magnetic recording medium such as a hard disc for the following circumstances.

The areal density of the magnetic recording medium is intended to be increased by improvement such as making magnetic particles for forming a recording layer finer, replacement of a material, and refined processing of a head. The areal density is expected to be further improved in the future.

However, problems such as a processing limit of a head, a side fringe due to expansion of a magnetic field, and crosstalk become obvious. Thus, the areal density by a conventional improvement technique is facing the limits of improvement. For this reason, as a magnetic recording medium being considered for realizing further improvement of the areal density, a discrete track medium and a patterned medium, each including a recording layer formed in a predetermined concavo-convex pattern, have been proposed (for example, see Japanese Patent Laid-Open Publication No. Hei 9-97419).

As a processing technique of processing a recording layer into a concavo-convex pattern, a dry etching technique such as ion beam etching or reactive ion etching (for example, see Japanese Patent Laid-Open Publication No. Hei 12-322710) can be used. In order to process a recording layer in a desired concavo-convex pattern by dry etching, one or a plurality of mask layers against dry etching are required to be formed on a recording layer, followed by processing the mask layer(s) into a concavo-convex pattern. As a technique of processing the mask layer into the concavo-convex pattern, the following technique is conceivable. A resist layer is first formed on the mask layer. Then, the resist layer is exposed to light and developed by a lithography technique so as to be processed into a concavo-convex pattern. By using the resist layer as a mask, the mask layer is processed by dry etching. However, the use of lithography technique for each of the magnetic recording media has a disadvantage in productivity.

On the other hand, the productivity can be remarkably improved by abutting a stamp on a resist layer so as to transfer a concavo-convex pattern thereto. The resist layer remains on a bottom part of a concave portion simply by transfer of the concavo-convex pattern, resulting in inexposure of the mask layer. However, by uniformly etching the resist layer to such a degree that the resist layer of the bottom part of the concave portion is removed, the mask layer is exposed at the bottom part of the concave portion. At the same time, the resist layer can be left as a convex portion by the amount corresponding to a step formed by the transfer.

In order to process the mask layer, the resist layer forming the convex portion is often required to be formed relatively thick. On the other hand, as shown in FIG. 16, a concave portion 102 formed on an object to be processed 100 (for example, a recording layer of a magnetic recording medium) by dry etching has a slightly tapered lateral face 102A. Therefore, as separating away from a mask 104 (in a downward direction in FIG. 16), the width of the concave portion 102 tends to gradually decrease. Therefore, it is necessary to transfer onto the resist layer a concave portion having a larger width than that of a desired concave portion to be formed on the object to be processed 100. In other words, it is necessary to transfer onto the resist layer a concavo-convex pattern including a convex portion having a smaller width than that of a desired convex portion to be formed on the object to be processed 100. For example, it is sometimes required to transfer a concavo-convex pattern including a convex portion at a relatively large aspect ratio, for example, at an aspect ratio exceeding 1. Herein, the aspect ratio is obtained by dividing the height by the width.

In order to transfer the concavo-convex pattern including a convex portion at such a large aspect ratio, a stamp carrying a concavo-convex pattern including a concave portion at a large aspect ratio (obtained by dividing a depth by a width) is needed. For manufacturing the stamp carrying such a concavo-convex pattern, a concavo-convex pattern including a convex portion at a large aspect ratio is required to be formed on a glass master.

However, the convex portion of the glass master is made of a resist material. Therefore, a resist material having a low rigidity is formed on a glass substrate to be thick so as to form the concavo-convex pattern including a convex portion at a large aspect ratio on the glass master. Accordingly, when the concavo-convex pattern is formed by exposure and development with a lithography technique, the resist material forming the convex portion is likely to be deformed or broken. As a result, there arises a problem of lowered transfer accuracy of the concavo-convex pattern and lowered processing accuracy of the recording layer.

In addition, there also arises a problem that the resist material forming the convex portion is likely to be deformed or broken when the stamp is manufactured by forming a thin film on the glass master by plating or the like as described above.

### SUMMARY OF THE INVENTION

In view of the foregoing problems, various exemplary embodiments of this invention provide a method for manufacturing a master for concavo-convex pattern transfer, which enables highly accurate manufacture of a master carrying a concavo-convex pattern including a convex portion at a large aspect ratio, and a method for manufacturing a stamp using the master.

Various exemplary embodiments of the present invention have achieved the above object by forming a mask in a predetermined concavo-convex pattern on an object to be etched having a higher rigidity than that of a resist material and etching the object to be etched so as to process the object to be etched into a concavo-convex pattern, and by employing, as a material of the mask, a material having a lower etching rate than that of the resist material and that of the object to be etched. Specifically, if a material having a lower etching rate than that of the resist material and that of the object to be etched is used as a material of the mask, a mask to be formed on the object to be etched can be correspondingly thin. Therefore, even when the mask is processed into the concavo-convex pattern, the mask is unlikely to be deformed or broken. As a result, the mask having the concavo-convex pattern with good profile accuracy can be obtained. The object to be etched can be processed in a desired concavo-convex pattern with high accuracy by etching the object with the use of the mask with such good profile accuracy. Furthermore, if the convex portion is formed by the object to be etched having a higher rigidity than that of the resist material instead of forming the convex portion of the resist material as in a conventional case, the deformation and break of the concavo-convex pattern can be remarkably reduced.

Accordingly , various exemplary embodiments of the invention provide

a method for manufacturing a master for concavo-convex pattern transfer, comprising the step of:

forming a mask in a predetermined pattern on an approximately plate-like shaped object to be etched having a higher rigidity than that of a resist material and then etching the object to be etched so as to process the object to be etched into a concavo-convex pattern, wherein a material having a lower etching rate to the etching than an etching rate of the resist material and an etching rate of the object to be etched as a material of the mask is used to obtain a master for transferring the concavo-convex pattern. Various exemplary embodiments of the invention provide

a method for manufacturing a stamp for manufacturing an information recording medium, comprising the steps of:

forming a stamp material in accordance with the concavo-convex pattern of the master for concavo-convex pattern transfer obtained by the method for manufacturing a master for concavo-convex pattern transfer described above; and stripping the stamp material off to obtain a stamp for manufacturing an information recording medium.

The term “aspect ratio” of a convex portion throughout this specification is used to mean a value obtained by dividing the height by the minimum width in an approximately perpendicular direction to a height direction of the convex portion.

The term “etching rate” throughout the specification is used to mean the amount of processing by etching per unit time.

According to various exemplary embodiments of the present invention, a master carrying a concavo-convex pattern including a convex portion at a large aspect ratio can be manufactured with high accuracy. As a result, an information recording medium such as a magnetic recording medium can be efficiently manufactured with high accuracy.

### BRIEF DESCRIPTION OF THE DRAWINGS

Various exemplary embodiments of the present invention will be described in detail with reference to the accompanying drawings, wherein:

FIG. 1 is a side sectional view schematically showing a structure of a master for concavo-convex pattern transfer according to a first exemplary embodiment of the present invention;

FIG. 2 is a flowchart showing the outline of a manufacture process of the master for concavo-convex pattern transfer;

FIG. 3 is a side sectional view schematically showing a structure of an object to be processed in the manufacture process of the master for concavo-convex pattern transfer;

FIG. 4 is a side sectional view schematically showing a shape of the object to be processed, in which a resist layer is processed into a concavo-convex pattern;

FIG. 5 is a side sectional view schematically showing a state where a mask layer is deposited on the resist layer;

FIG. 6 is a side sectional view schematically showing a state where the resist layer is removed;

FIG. 7 is a side sectional view schematically showing a state where a concavo-convex pattern is formed on the object to be etched;

FIG. 8 is a side sectional view schematically showing a state where a conductive film is formed on the master for concavo-convex pattern transfer;

FIG. 9 is a side sectional view schematically showing a state where an electrolytic plating layer is formed on the conductive film;

FIG. 10 is a side sectional view schematically showing a state where a stamp is stripped off from the master for concavo-convex pattern transfer;

FIG. 11 is a side sectional view schematically showing the transfer of a concavo-convex pattern to an object to be processed of a magnetic recording medium by the stamp;

FIG. 12 is a side sectional view schematically showing a structure of a master for concavo-convex pattern transfer according to a second exemplary embodiment of the present invention;

FIG. 13 is a side sectional view schematically showing a structure of a master for concavo-convex pattern transfer according to a third exemplary embodiment of the present invention;

FIG. 14 is a side sectional view schematically showing a structure of a master for concavo-convex pattern transfer according to a fourth exemplary embodiment of the present invention;

FIG. 15 is a graph showing the relation between an etching rate ratio and an angle of a lateral face of a concave portion in Working Example 2 of the present invention; and

FIG. 16 is a side sectional view schematically showing a concavo-convex shape formed on an object to be etched by dry etching.

### DETAILED DESCRIPTION OF THE PREFERRED EMBODIMENT

Various exemplary embodiments of this invention will be hereinafter described in detail with reference to the drawings.

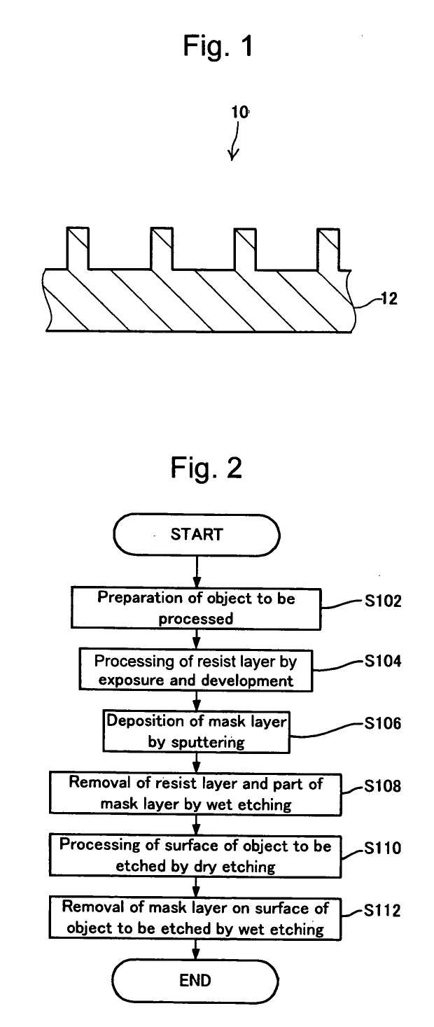

As shown in FIG. 1, a master 10 for concavo-convex pattern transfer according to this first exemplary embodiment has such a structure that a concavo-convex pattern is formed on a surface of an object to be etched 12.

The object to be etched 12 is made of a Si (silicon) plate with a higher rigidity than that of a resist material. The concavo-convex pattern formed on the surface of the object to be etched 12 includes a convex portion at an aspect ratio exceeding 1.

The master 10 for concavo-convex pattern transfer has a characteristic in a processing step of forming a concavo-convex pattern on the surface of the object to be etched 12 by etching. In accordance with a flowchart of FIG. 2, a method of processing the object to be etched 12 will be described.

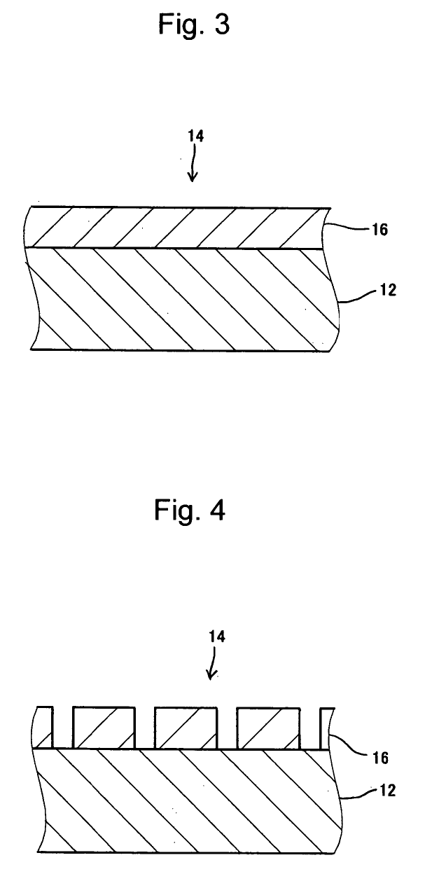

First, an object to be processed 14 for manufacturing the object to be etched 12 as shown in FIG. 3 is prepared (S102). The object to be processed 14 is obtained by applying a resist layer 16 on a material of the plate object to be etched 12 having a flat surface by spincoating or the like. The resist layer 16 may also be applied by other depositing techniques such as doctor blade.

As a material of the resist layer 16, any of a positive resist material and a negative resist material may be used.

The resist layer 16 of the thus obtained object to be processed 14 is exposed to light in a predetermined pattern using an electron beam exposure device (not shown) followed by development. Then, as shown in FIG. 4, the resist layer 16 is partially removed (S104).

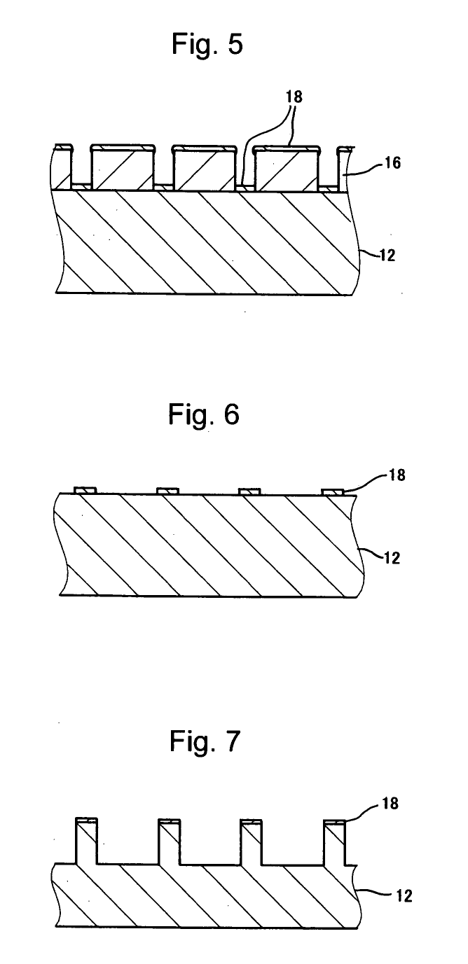

Next, as shown in FIG. 5, a mask layer 18 is deposited on the object to be processed 14 by sputtering or the like (S106). The mask layer 18 is deposited on parts of the object to be etched 12 exposed through the resist layer 16 and the remaining resist layer 16. As a material of the mask layer 18, Ni (nickel) is used. Nickel has a lower etching rate to reactive ion etching using an SF₆ (sulfur hexafluoride) gas as a reactive gas than that of the resist layer 16 and that of the object to be etched 12. The mask layer 18 may be deposited by other deposition techniques such as CVD (Chemical Vapor Deposition) or IBD (Ion Beam Deposition).

In order to form a concavo-convex pattern on the object to be etched 12 so that a lateral face of a concave portion is nearly perpendicular, it is preferable that an etching rate ratio be 10 or more. The etching rate ratio is obtained by dividing the etching rate of the object to be etched 12 by the etching rate of the mask layer 18. Since the etching rate ratio, which is obtained by dividing the etching rate of Si to the reactive ion etching using the SF₆ gas as a reactive gas by the etching rate of Ni, is approximately 43.4, this first exemplary embodiment satisfies the above condition. The mask layer 18 is formed thin so that its thickness becomes about an inverse multiple of the etching rate ratio with respect to the step of the concavo-convex pattern that is formed on the object to be etched 12.

Next, the resist layer 16 is removed by wet etching as shown in FIG. 6 (S108). As a result, the mask layer 18 on the resist layer 16 is also removed. Only the mask layer 18 deposited on the parts of the object to be etched 12, which were exposed through the resist layer 16, remains to form convex portions of the concavo-convex pattern. The mask layer 18 is made of Ni and therefore has a higher rigidity than that of the resist material. In addition, since the mask layer 18 is formed thin on the object to be etched 12, the mask layer 18 is hardly deformed or broken. Specifically, the mask layer 18 remains on the object to be etched 12 while keeping the concavo-convex pattern obtained by highly accurate transfer of the exposure pattern of the resist layer 16.

Next, by the reactive ion etching using the SF₆ gas as a reactive gas, the parts of the object to be etched 12, which are exposed through the mask layer 18, are processed as shown in FIG. 7 (S110). Since the mask layer 18 keeps the concavo-convex pattern formed by highly accurate transfer of the exposure pattern of the resist layer 16, the concavo-convex pattern, which is formed by highly accurate transfer of the exposure pattern of the resist layer 16, is also formed on the object to be etched 12. Furthermore, since the mask layer 18 is formed thin, the lateral face of the concave portion formed on the object to be etched 12 is processed in a nearly perpendicular shape whose taper is kept small. Also in this regard, the concavo-convex pattern with good profile accuracy is formed. An extremely small amount of the mask layer 18 remains on the object to be etched 12.

Next, for example, by wet etching using aqua regia, the mask layer 18 remaining on the object to be etched 12 is removed and cleaned (S112). As a result, the processing of the object to be etched 12 is completed to obtain the master 10 for concavo-convex pattern transfer as shown in FIG. 1.

As described above, by using a material whose etching rate is lower than that of the resist material and that of the object to be etched 12 as a material of the mask layer 18, the thickness of the mask layer 18 to be formed on the object to be etched 12 can be correspondingly small. As a result, even if the mask layer 18 is processed into a concavo-convex pattern, the deformation and the break hardly occur to improve the profile accuracy of the concavo-convex pattern of the mask layer 18. By etching the object to be etched 12 by using the mask layer 18 carrying the concavo-convex pattern with good profile accuracy, the concavo-convex pattern can be formed on the object to be etched 12 with good accuracy. Furthermore, since the mask layer 18 is formed thin, the lateral face of the concave portion formed on the object to be etched 12 is processed in a nearly perpendicular shape whose taper is kept small. Also in this regard, the concavo-convex pattern with good profile accuracy is formed. Furthermore, since the concave portions and the convex portions are formed on the object to be etched 12 having a higher rigidity than that of the resist material, the deformation and the break of the concavo-convex pattern can be remarkably reduced as compared with a conventional glass master whose convex portions are formed of a resist material or the like.

Next, a method of manufacturing a stamp for manufacturing an information recording medium using the master 10 for concavo-convex pattern transfer will be described.

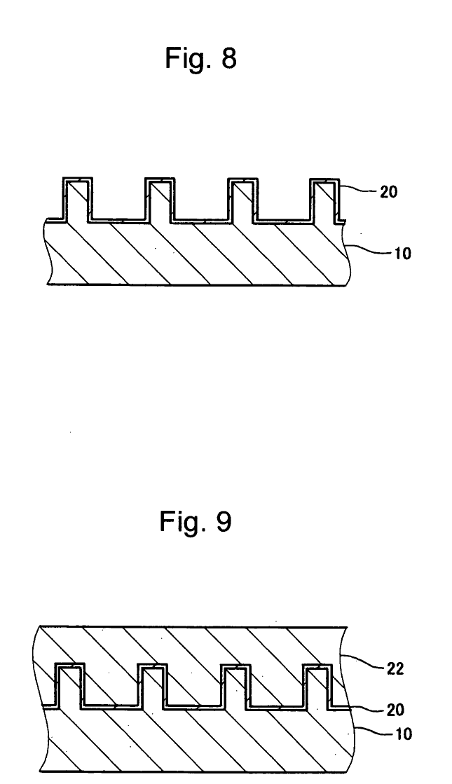

First, as shown in FIG. 8, a conductive film 20 made of Ni at a thickness of several tens of nm is formed on the surface of the master 10 for concavo-convex pattern transfer by sputtering.

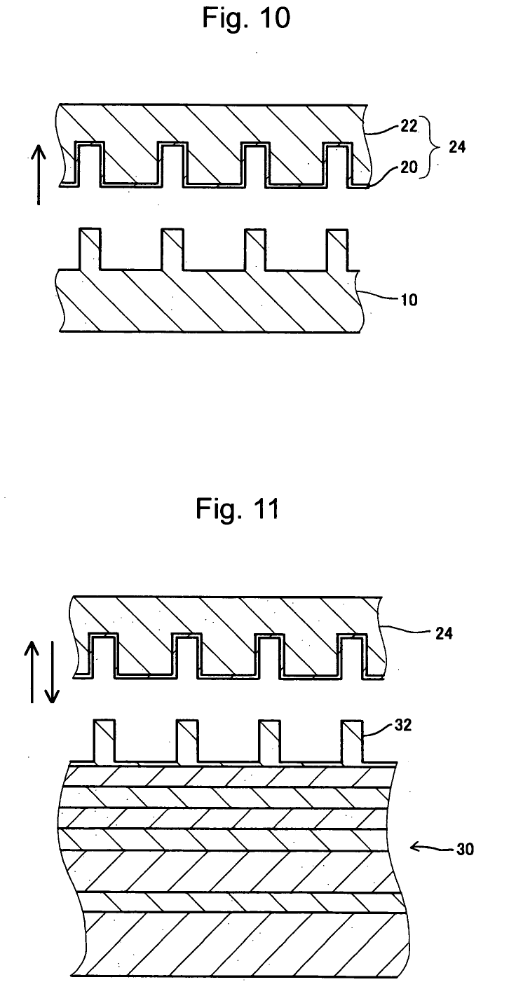

Next, the master 10 for concavo-convex pattern transfer is immersed into a nickel sulfamate solution. Then, a current is allowed to flow using the conductive film 20 as an electrode so as to grow a nickel film to a thickness of several hundreds of μm. In this manner, an electrolytic plating layer 22 as shown in FIG. 9 is formed. Furthermore, after the face of the electrolytic plating layer 22, which is opposite to the conductive film 20 side, is polished, the conductive film 20 and the electrolytic plating layer 22 are simultaneously stripped off from the master 10 for concavo-convex pattern transfer. The outer peripheries and the like of the conductive film 20 and the electrolytic plating layer 22 are punched as needed to fix the shape. After foreign mattes adhered thereto are removed by a caustic soda, the conductive film 20 and the electrolytic plating layer 22 are subjected to ultrasonic cleaning with ultrapure water. As a result, a stamp 24 for manufacturing an information recording medium is completed.

By using the thus obtained stamp 24 for manufacturing an information recording medium, a concavo-convex pattern is abutted on a resist layer 32 applied on the surface of an object to be processed 30 of a magnetic recording medium as shown in FIG. 11. As a result, the concavo-convex pattern identical with that of the master 10 can be transferred to the resist layer 32. FIG. 11 shows an example where various layers are deposited over a substrate as an example of an object to be processed in this case. However, since these layers are not directly concerned with the present invention, the detailed description thereof is herein omitted.

If another stamp (not shown) is manufactured by the same electrolytic plating as that described above using the stamp 24 as a metal master, a reversed concavo-convex pattern to the master 10 can be transferred to the resist layer 32.

Moreover, if a mother (not shown) is manufactured by the same electrolytic plating as that described above using the stamp 24 as a metal master so as to be used to manufacture a stamp (not shown) by the electrolytic plating as described above using the mother, the concavo-convex pattern identical with that of the master 10 can be transferred to the resist layer 32. It is apparent that the electrolytic plating can be further repeated to manufacture another stamp.

The material of the object to be etched 12 for the master 10 for concavo-convex pattern transfer is Si in the first exemplary embodiment. However, other materials having a higher rigidity than a resist material can also be used as a material of the object to be etched 12. Examples thereof include glass, SiC (silicon carbide), glassy carbon, SiO₂ (silicon dioxide), Ta (tantalum), TiN (titanium nitride), Ag (silver), a CoCrPt (cobalt-chromium-platinum) alloy, and an FePt (iron-platinum) alloy.

The material of the mask layer 18 is Ni in the first exemplary embodiment. However, other materials such as Ta may be used as a material of the mask layer 18 as long as its etching rate at the step of processing the object to be etched 12 (S110) is lower than those of the resist material and the object to be etched 12. In order to form the concavo-convex pattern having a nearly perpendicular lateral face on the object to be etched 12, it is preferred that the kind of etching, the material of the object to be etched 12 and the material of the mask layer 18 are selected so that the etching rate ratio, which is obtained by dividing the etching rate of the object to be etched 12 by the etching rate of the mask layer 18, becomes 10 or more.

The reactive ion etching using the SF₆ gas as a reactive gas is used so as to form a concavo-convex pattern on the surface of the object to be etched 12 in the first exemplary embodiment. The concavo-convex pattern may be formed on the object to be etched 12 by using reactive ion etching using other halogen gases, reactive ion etching using a reactive gas containing CO (carbon monoxide), or other dry etching techniques such as ion beam etching.

The etching rate ratios of the object to be etched 12 to the mask layer 18 exemplified above are shown in Table 1.

TABLE 1

| | | | Etching |
|---|---|---|---|
| Object to | | | selection |
| be etched | Mask | Type of dry etching | ratio |
| SiC | Ni | RIE (SF₆ gas) | 20 |
| Glassy | Ni | RIE (SF₆ gas) | 16.4 |
| carbon | | | |
| SiO₂ | Ni | RIE (SF₆ gas) | 12.7 |
| Si | Ni | RIE (SF₆ gas) | 43.4 |
| Ta | Ni | RIE (SF₆ gas) | 13.2 |
| TiN | Ni | RIE (SF₆ gas) | 29.5 |
| Ag | Ta | RIE (CO + NH₃gas) | 77.2 |
| CoCrPt | Ta | RIE (CO + NH₃gas) | 37.2 |
| FePt | Ta | RIE (CO + NH₃gas) | 23 |
| SiO₂ | Ta | RIE (CO + NH₃gas) | 12.1 |

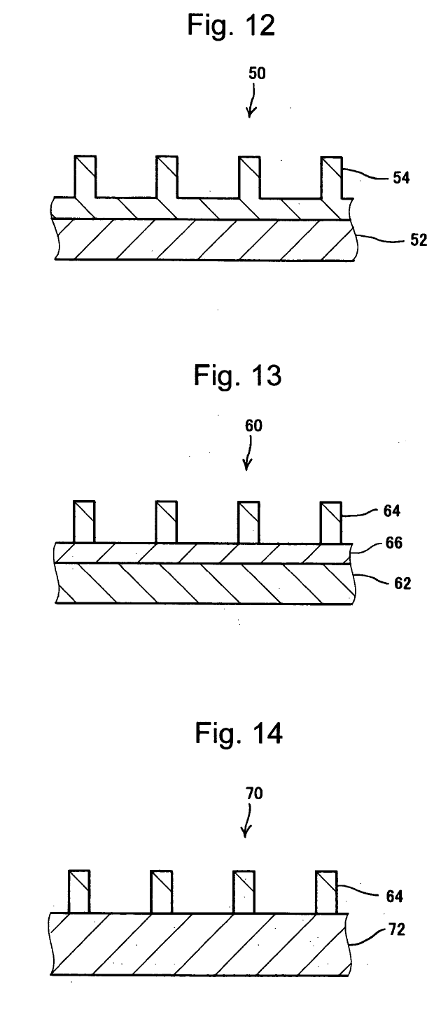

Although the master 10 for concavo-convex pattern transfer has a single-layered structure in the first exemplary embodiment, a master for concavo-convex pattern transfer may also have a double-layered structure as a master 50 for concavo-convex pattern transfer according to the second exemplary embodiment of the present invention shown in FIG. 12. In the master 50 for concavo-convex pattern transfer, an object to be etched 54 is deposited on a substrate 52 by, for example, sputtering to form a double-layered structure. Then, a concavo-convex pattern is formed on the object to be etched 54. In this case, if a material having conductivity such as Ag or Ta is used as a material of the object to be etched 54, when a stamp for manufacturing an information recording medium is manufactured from the master 50 for concavo-convex pattern transfer, it is possible to conduct electrolytic plating without forming a conductive film by sputtering or electroless plating. Accordingly, the production efficiency of the stamp for manufacturing an information recording medium can be improved.

The master 50 for concavo-convex pattern transfer has such a structure that the object to be etched 54 is partially removed in a thickness direction to form a concavo-convex pattern. However, a concavo-convex pattern may be formed as in the case of a master 60 for concavo-convex pattern transfer according to a third exemplary embodiment of the present invention shown in FIG. 13. An underlayer 66, which has a lower etching rate to predetermined etching than that of an object to be etched 64, is formed on a substrate 62. The object to be etched 64 is formed on the underlayer 66. The object to be etched 64 is removed to the underlayer 66 by etching so as to form the concavo-convex pattern.

In this manner, a depth of concave portions of the concavo-convex pattern formed on the master for concavo-convex pattern transfer can be uniformized. Correspondingly, a concavo-convex pattern including convex portions having a uniform height can be formed on the stamp for manufacturing an information recording medium. Moreover, the surface roughness of the bottom part of the concave portion formed on the master for concavo-convex pattern transfer can be reduced. A convex portion having correspondingly reduced roughness on its end face can be formed on the stamp for manufacturing an information recording medium.

In this case, for example, if a material having conductivity such as Ag is used as a material of the object to be etched 64 and the underlayer 66 is also made of a material having conductivity such as Ta, the electrolytic plating can be conducted without sputtering or electroless plating, as in the second exemplary embodiment, thereby improving the production efficiency of the stamp for manufacturing an information recording medium.

Although the underlayer 66 is formed on the substrate 62 in the third exemplary embodiment, as a master 70 for concavo-convex pattern transfer according to a fourth exemplary embodiment of the present invention shown in FIG. 14, a underlayer 72 may also serve as a substrate.

The mask layer 18 is processed into a concavo-convex pattern by using a lift-off method in the above-described first exemplary embodiment. However, a processing technique of the concavo-convex pattern is not particularly limited as long as the mask layer 18 is formed in a concavo-convex pattern on the object to be etched 12. For example, the following technique may be used to process the mask layer 18 into a concavo-convex pattern. A mask layer and a resist layer are uniformly formed on the object to be etched 12 in this order. After exposure and development of the resist layer, the mask layer 18 is processed into a concavo-convex pattern by using a dry etching technique such as ion beam etching.

The concavo-convex pattern is transferred to the object to be processed of the magnetic recording medium by using the stamp 24 for manufacturing an information recording medium in the first exemplary embodiment described above. Alternatively, for example, the present invention is applicable to the manufacture of other information recording media as long as the information recording medium requires the transfer of a concavo-convex pattern in the manufacture process such as an optical recording medium.

Moreover, the concavo-convex pattern can be directly transferred from the master for concavo-convex pattern transfer to the object to be processed of a magnetic recording medium or the like even without using the stamp for manufacturing an information recording medium.

### WORKING EXAMPLE 1

In the manner as described in the first exemplary embodiment above, the master 10 for concavo-convex pattern transfer was manufactured. Specifically, the concavo-convex patterns of an object to be etched, a mask layer, and a resist layer were formed in the following size. As a material of the resist layer 16, a positive electron beam resist ZEP520A (Zeon Corporation) was used.

Object to be Etched:

Pitch of concavo-convex pattern: approx. 150 nm

Width of convex portion: approx. 50 nm

Width of concave portion: approx. 100 nm

Level difference between concavity and convexity: approx. 150 nm

Resist Layer:

Thickness: 90 nm

Width of convex portion: approx. 100 nm

Width of a concave portion: approx. 50 nm

Mask Layer:

Thickness: 15 nm

Width of convex portion: approx. 50 nm

Width of concave portion: approx. 100 nm

A value obtained by dividing 150 nm, corresponding to the level difference between concavity and convexity formed on the object to be etched, by 43.4 corresponding to an etching rate ratio of the object to be etched to the mask layer is 3.4 nm. Therefore, the mask layer was formed thicker than this value so as to have a thickness of 15 nm. This is because a margin as a mask was taken into consideration.

A shape of a side cross-section of the thus obtained concavo-convex pattern of the master 10 for concavo-convex pattern transfer was observed with a microscope. As a result, no deformation, break or the like of a convex portion was observed; the profile of the concavo-convex pattern was good.

### WORKING EXAMPLE 2

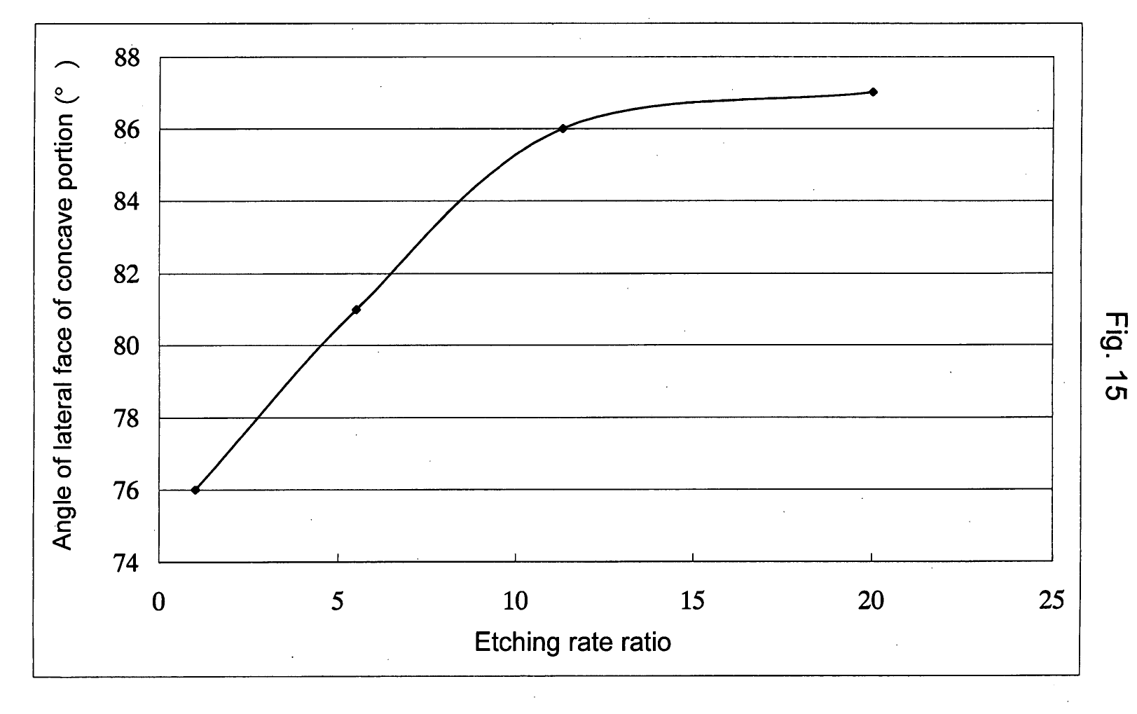

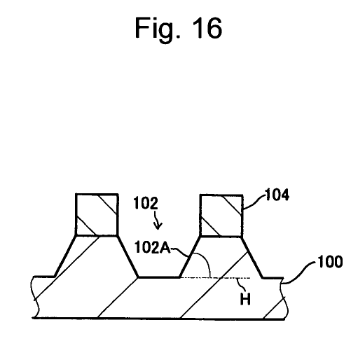

A plurality of materials of the object to be etched and the mask were selected. For each combination of the materials, a concave portion having a width of approx. 100 nm and a depth of approx. 150 nm was formed on the object to be etched by reactive ion etching using an SF₆ gas as a reactive gas. Then, the relation between the etching rate ratio and the angle of a lateral face of the concave portion was measured. Herein, the etching rate ratio is obtained by dividing the etching rate of the object to be etched by the etching rate of the mask material. In the process of any combination of materials, a source power of the reactive ion etching was set to 1000 W and a bias power thereof was set to 150 W. On the other hand, a pressure in a vacuum chamber was regulated in accordance with a material. The results of measurement were shown in Table 2 and FIG. 15. The pressure in the vacuum chamber was also shown in Table 2. The angle of the lateral face of the concave portion was indicated as an angle with respect to a horizontal plane H in FIG. 16.

As can be seen from FIG. 15, if the etching rate ratio is 10 or more, the angle of the lateral face of the concave portion becomes 85 degrees or more. As a result, the concave portion having a good profile with a nearly perpendicular lateral face can be formed. Moreover, as the etching rate ratio increases, the angle of the lateral face of the concave portion tends to increase. With the etching rate ratio of less than 10, the degree of increase of the angle of the lateral face of the concave portion with the increase of the etching rate ratio is large. However, when the etching rate ratio becomes 10 or more, the increase of the angle of the lateral face of the concave portion with the increase of the etching rate ratio remarkably slows down. Therefore, in order to form the concave portion in a good profile with a nearly perpendicular lateral face, it is preferred to select the materials of the object to be etched and the mask so that the etching rate ratio becomes 10 or more.

TABLE 2

| | | Etching | Angle of lateral | Pressure in |
|---|---|---|---|---|
| Object to be | | selection | face of concave | vaccum chamber |
| etched | Mask | ratio | portion (°) | (Pa) |
| Si | ZEP520A | 1.02 | 76 | 0.35 |
| | (Resist | | | |
| | material) | | | |
| Pt | Ni | 5.5 | 81 | 0.5 |
| Ta | Ni | 11.3 | 86 | 0.4 |
| SiC | Ni | 20 | 87 | 0.6 |

### COMPARATIVE EXAMPLE

In contrast with Working Example 1 described above, a resist material was applied at a thickness of approx. 150 nm on a substrate. Then, a concavo-convex pattern in the dimension given below, same as in Working Example 1 was attempted to be formed so that the resist material formed the convex portions. As a result, the convex portions broken, failing to be used as a master.

Pitch of concavo-convex pattern: approx. 150 nm

Width of convex portion: approx. 50 nm

Width of concave portion: approx. 100 nm

Level difference between concavity and convexity: approx. 150 nm

The various exemplary embodiments of the present invention can be used to manufacture an information recording medium including a recording layer carrying a concavo-convex pattern such as a magnetic recording medium or an optical recording medium, for example, a discrete track medium, a patterned medium or the like.

1. A method for manufacturing a master for concavo-convex pattern transfer, comprising the step of:
forming a mask in a predetermined pattern on an approximately plate-like shaped object to be etched having a higher rigidity than that of a resist material and then etching the object to be etched so as to process the object to be etched into a concavo-convex pattern, wherein a material having a lower etching rate to the etching than an etching rate of the resist material and an etching rate of the object to be etched as a material of the mask is used to obtain a master for transferring the concavo-convex pattern.

2. The method for manufacturing a master for concavo-convex pattern transfer according to claim 1, wherein
the object to be etched is formed on an underlayer having a lower etching rate to the etching than the etching rate of the object to be etched, and the object to be etched is removed to the underlayer by the etching so as to be processed into the concavo-convex pattern.

3. The method for manufacturing a master for concavo-convex pattern transfer according to claim 2, wherein
the underlayer also serves as a substrate.

4. The method of manufacturing a master for concavo-convex pattern transfer according to claim 1, wherein
a material having conductivity is used as a material of the object to be etched.

5. The method for manufacturing a master for concavo-convex pattern transfer according to claim 2, wherein
a material having conductivity is used as materials of the object to be etched and the underlayer.

6. The method for manufacturing a master for concavo-convex pattern transfer according to claim 1, wherein
an etching rate ratio obtained by dividing the etching rate of the object to be etched to the etching by the etching rate of the mask is 10 or larger.

7. The method for manufacturing a master for concavo-convex pattern transfer according to claim 1, wherein
the concavo-convex pattern including a convex portion at an aspect ratio exceeding 1 is formed, the aspect ratio being obtained by dividing a height by a width.

8. A method for manufacturing a stamp for manufacturing an information recording medium, comprising the steps of:
forming a stamp material in accordance with the concavo-convex pattern of the master for concavo-convex pattern transfer obtained by the method for manufacturing a master for concavo-convex pattern transfer according to claim 1; and
stripping the stamp material off to obtain a stamp for manufacturing an information recording medium.

9. The method for manufacturing a stamp for manufacturing an information recording medium, according to claim 8, wherein
the stamp material is formed in accordance with the concavo-convex pattern by plating.
